(19) United States
(12) Patent Application Publication
(10) Pub. No.: US 2009/0327661 A1
(43) Pub. Date: Dec. 31, 2009

(54) MECHANISMS TO HANDLE FREE PHYSICAL REGISTER IDENTIFIERS FOR SMT OUT-OF-ORDER PROCESSORS

(76) Inventors: Zeev Sperber, Zichron Yaakov (IL); David J. Sager, Portland, OR (US); Fernando Latorre, Huesca (ES); Ori Lempel, Haifa (IL); Evgeni Krimer, Eilat (IL); Bishara Shomar, Nazareth (IL)

Correspondence Address: Caven & Aghevli LLC;c/o CPA Global, P.O. BOX 52050, MINNEAPOLIS, MN, 55402, US

(21) Appl. No.: 12/165,186

(22) Filed: Jun. 30, 2008

(51) Int. Cl. G06F 9/305

(52) U.S. Cl. 712/217; 712/E09.018

(57) ABSTRACT

Methods and apparatus relating to mechanisms to handle free physical register identifiers for SMT (Simultaneous Multi-Threading) out-of-order processors are described. In some embodiments, a physical register file stores both speculative data and architectural data corresponding to a plurality of registers. A free list logic may maintain free physical register identifiers corresponding to the plurality of registers. An instruction may read the architectural data from the physical register file at dispatch. Other embodiments are also described and claimed.

### FIELD

The present disclosure generally relates to the field of electronics. More particularly, an embodiment of the invention relates to mechanisms to handle free physical register identifiers for SMT (Simultaneous Multi-Threading) out-of-order processors.

### BACKGROUND

To improve performance, some processors may execute instructions speculatively. For example, some instructions may be executed out of their original program order. This in turn may result in some speculatively processed instructions to use incorrect data as their input. This may end up in an erroneous result which needs to be flushed.

To maintain correctness, some processors may store the speculative data (values produced by micro-operations (uops) that have not been retired and therefore they may be incorrect) in a Reorder Buffer entry (also known as an ROB entry) allocated by the uop that produced the data. However, this ROB entry may be reclaimed once the uop retires. When a uop retires, its produced value becomes part of the architectural state of the processor and may be copied from the ROB entry to another location. Hence, uops that consume the value may read it from the ROB or another location. Once the value is read by the consumer; the consumer may keep the value in its Reservation Station (RS) entry until the uop is dispatched for execution. However, this approach requires that values be copied (when the uop that produced them retires) and the RS to store the values consumed by its uop. Hence, such implementations add overhead to and may introduce latency in operations of a processor.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 6, and 7 illustrate block diagrams of embodiments of computing systems, which may be utilized to implement various embodiments discussed herein.

FIG. 2 illustrates a block diagram of portions of a processor core and other components of a computing system, according to an embodiment of the invention.

FIGS. 4A-4D illustrate relative pointer positions in accordance with various embodiments.

FIG. 5 illustrates a flow diagram of a method in accordance with an embodiment of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof. Also, the use of “instruction” or “micro-operation” (which may also be referred to as “uop”) herein may be interchangeable.

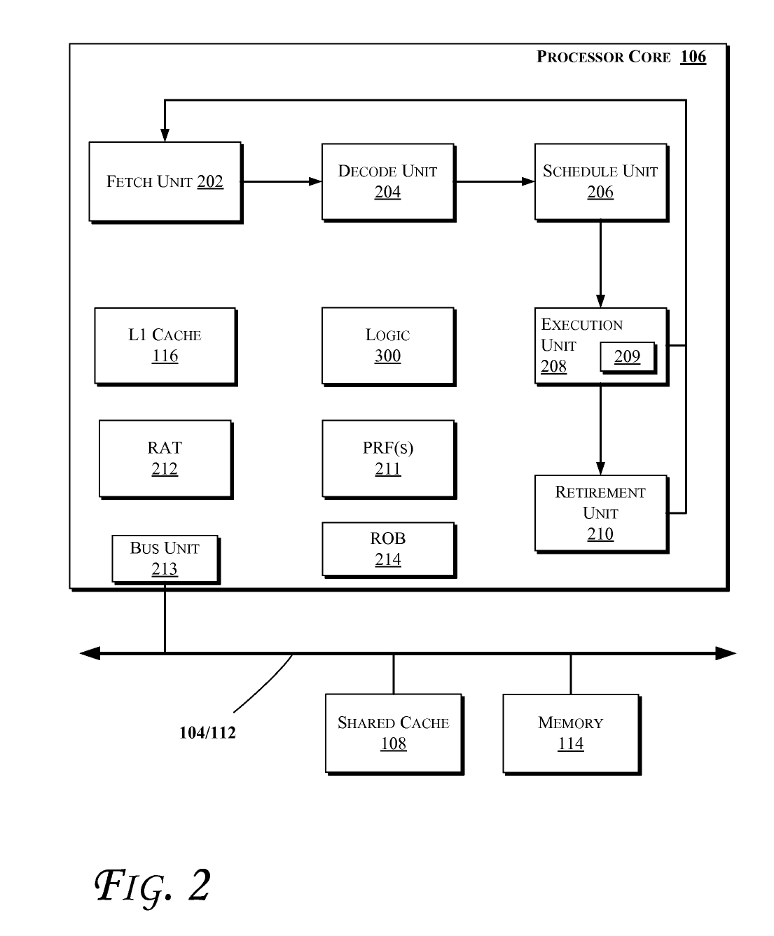

Some embodiments provide a Physical Register File (PRF) implementation (e.g., in the backend of a processor such as the processor of FIG. 2) that stores the speculative state as well as the architectural state. In an embodiment, the speculative data is stored in a PRF that is read by consumers at dispatch time. As discussed above, when a uop retires, its produced value(s) becomes part of the architectural state of the processor and is copied from the ROB entry, for example, to a Retirement Register File (RRF). To this end, some embodiments may be used to reduce overhead and/or latency associated with utilizing an ROB with a RRF. For instance, values do not have to be copied when the uop that produced them retires and/or the reservation stations do not have to store the values consumed by the uop. Moreover, in one embodiment, the value in the PRF is valid from allocation until the next retirement of that register. Moreover, some embodiments describe allocation and reclamation schemes for PRF entries executed following a branch misprediction, event or retirement. In an embodiment, a periodic recovery checkpoint (CP) may be utilized in conjunction with a PRF.

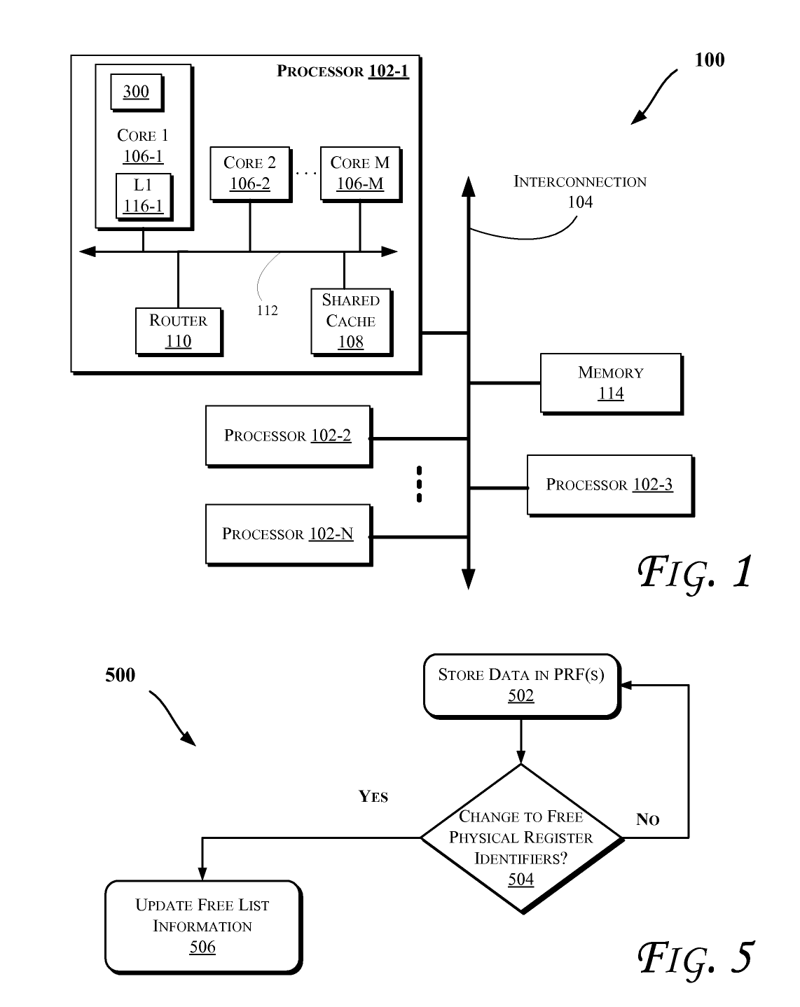

Techniques described herein may allow for improved performance in various processors, such as those discussed for example with reference to FIGS. 1-7. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection network or bus 104. Each processor may include various components, some of which are only discussed with reference to processor 102-1 for clarity. Accordingly, each of the remaining processors 102-2 through 102-N may include the same or similar components discussed with reference to the processor 102-1.

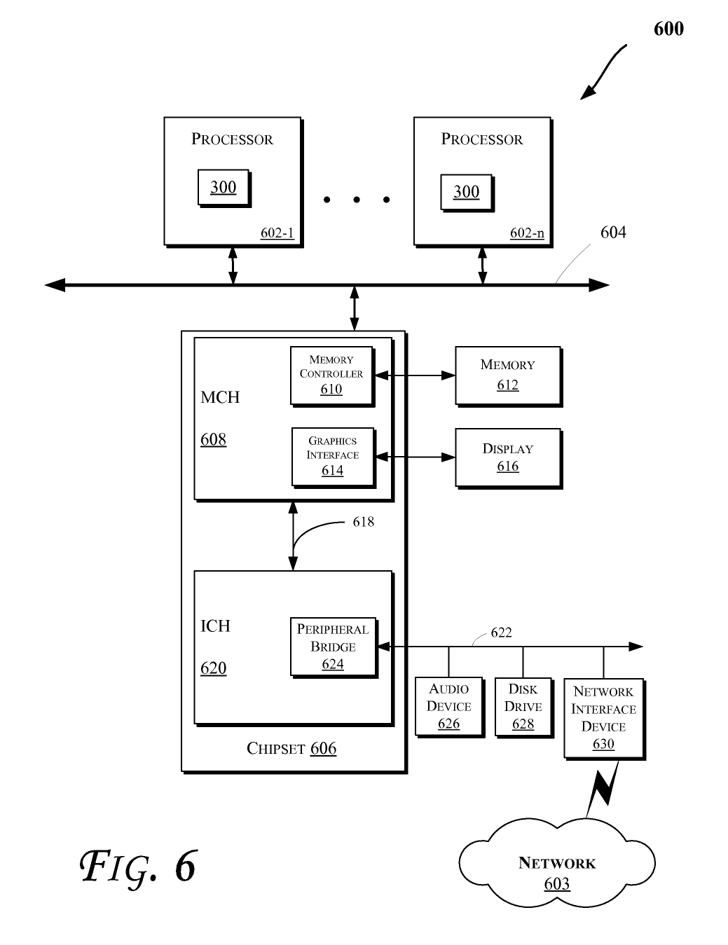

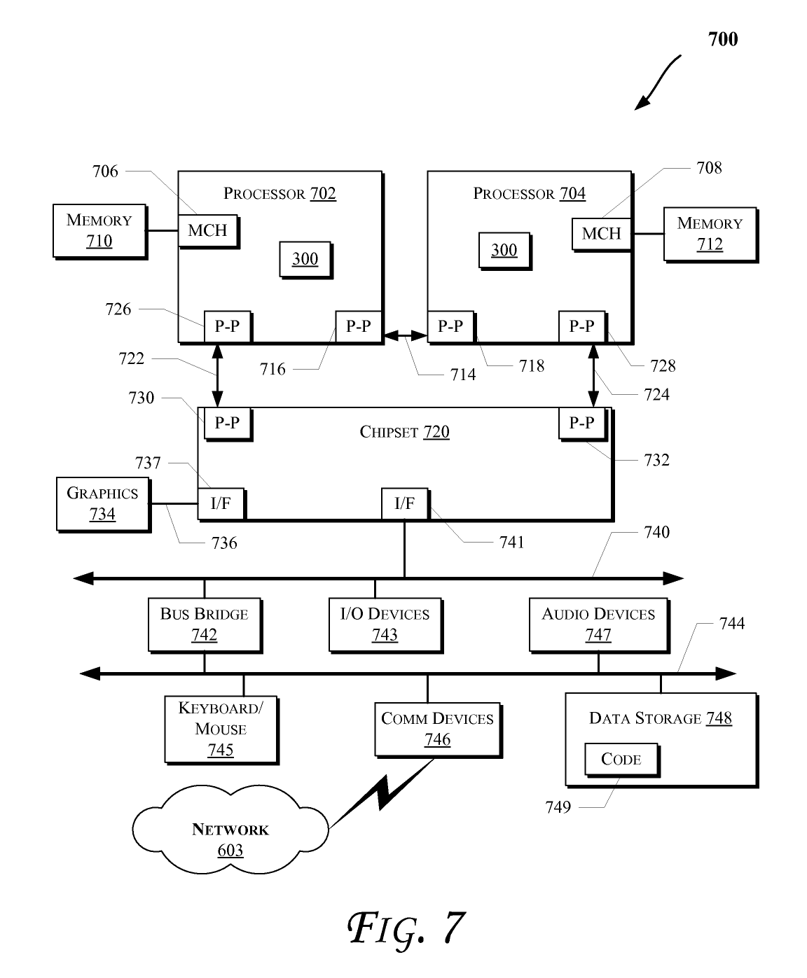

In an embodiment, the processor 102-1 may include one or more processor cores 106-1 through 106-M (referred to herein as “cores 106” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection network 112), memory controllers (such as those discussed with reference to FIGS. 6 and 7), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache (116-1) (generally referred to herein as “L1 cache 116”). Additionally, cores 106 may also include a logic 300, e.g., to handle the free register identifiers for the Integer and FP/SIMD (Single Instruction, Multiple Data) PRF (e.g. PRF 211). More than one PRF 211 may also be used in some embodiments, e.g., one each for Integer versus FP/SIMD. Further details of the logic 300 will be discussed herein with reference to FIGS. 2-7.

FIG. 2 illustrates a block diagram of portions of a processor core 106 and other components of a computing system, according to an embodiment of the invention. In one embodiment, the arrows shown in FIG. 2 illustrate the flow direction of instructions and/or data through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

As illustrated in FIG. 2, the processor core 106 may include a fetch unit 202 to fetch instructions for execution by the core 106. The instructions may be fetched from any storage devices such as the memory 114 and/or the memory devices discussed with reference to FIGS. 6 and 7. The core 106 may optionally include a decode unit 204 to decode the fetched instruction. In an embodiment, the decode unit 204 may decode the fetched instruction into a plurality of uops (micro-operations). Some embodiments of the processor core 106 may not include decode unit 204. Hence, the core 106 may process instructions without decoding them. Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution (e.g., in accordance with information provided by logic 300 which will be further discussed herein, e.g., with reference to FIG. 3). The execution unit 208 may execute the dispatched instructions after they are decoded (e.g., by the decode unit 204) and dispatched (e.g., by the schedule unit 206). In an embodiment, the execution unit 208 may include more than one execution unit, such as one or more memory execution units, one or more integer execution units, one or more floating-point execution units 209, or other execution units. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. Also, each core 106 may be capable of executing multiple threads simultaneously (SMT or Simultaneous Multi-Threading). The core 106 may also include a retirement unit 210. The retirement unit 210 may retire executed instructions (e.g., in order) after they are committed. In an embodiment, retirement of the executed instructions may result in processor state being committed from the execution of the instructions, physical registers used by the instructions being de-allocated, etc.

Additionally, the core 106 may include a bus unit 213 to allow communication between components of the processor core 106 and other components (such as the components discussed with reference to FIG. 1) via one or more buses (e.g., buses 104 and/or 112). As shown, the core 106 may also include a Register Alias Table (RAT) 212 (e.g., to maintain a mapping of logical registers (such as those identified by operands of software instructions) to corresponding physical registers) and an ROB 214 (e.g., to store information about in-flight instructions (or uops) for access by various components of the processor core 106).

FIG. 3 illustrates a block diagram of a free list logic 300, in accordance with an embodiment. In some embodiments, the logic 300 may be provided in a processor (or a processor core) to handle free physical register identifiers, e.g., for SMT out-of-order processors. In an embodiment, one or more of the components shown in FIG. 3 may be incorporated in various processors, such as those discussed with reference to FIGS. 1-2 and 6-7. Also, various storage units (also referred to as “arrays” or “memories” herein) discussed with reference to logic 300 may be provided by using a cache (whether private or shared) or a main memory such as those discussed with reference to FIGS. 1-2 and 6-7.

Moreover, in some embodiments, processors that store the architectural and speculative state in the same PRF (e.g., PRF 211 of FIG. 2) reclaim the physical registers in an order that differs from the order they were originally allocated (the physical register that maps the architectural copy of a register (like EAX or XMM0) may not be reclaimed until the time the next copy of that register retires). Therefore, this kind of architectures may use a hardware mechanism that stores the register identifiers of the physical registers that are not being used and therefore they may be allocated by new instructions. As discussed herein, we refer to this structure as a free list (FL). This structure (logic 300) may handle the free register identifiers for the Integer and FP/SIMD PRFs (e.g., PRF 211 of FIG. 1). In some embodiments, a processor may execute at least a first thread and a second thread, where the free list logic 300 may reclaim one or more entries in an order comprising: (1) first, reclaim one or more entries from the PHT corresponding to the first thread; (2) second, reclaim one or more entries from the PHT corresponding to the second thread; and (3) third, reclaim one or more entries from the PRRT according to an amount of PRRT entries corresponding to each of the first or second thread.

In an embodiment, the FL logic 300 may include an allocation control logic 302, a reclamation control logic 304, and FL arrays (e.g., including Integer FL array 306, FP/SIMD FL array 308, PRRT (Post Retirement Reclamation Table) 310, PHT (PDst (Physical Destination) History Table) 312, and RHT (RAT (Register Alias Table) History Table) 314) as depicted in FIG. 3. More particularly, as shown in FIG. 3, the FL array block may be separated into the following arrays:

(a) Integer FL array 306 and FP/SIMD FL array 308—these arrays contain the free entries in the Integer or FP/SIMD PRF, respectively. Entries may be allocated from these arrays, for example, if the destination type is Integer to Integer FL array 306 or if the destination type is X87 (Non-Packed_FP operations), MMX (Multi Media eXtension), SSE (Streaming SIMD Extension), or AVX (Advanced Vector Extensions) to FP_SIMD FL array 308;

(b) RHT 314 and PHT 312: these tables contain the information needed to recover the RAT (e.g., RAT 212 of FIG. 2) and FL in case of misprediction or an event. The PHT holds the current PDst pointer needed to be reclaimed in case of a branch misprediction or event detection; and

(c) PRRT 310—contains the previous PDst pointer of the logical register that will be reclaimed in case the ROB 214 entry associated with that PRRT entry is retired.

Moreover, dividing the register file into integer and XMM arrays is not a necessity, as the number of arrays depends on the specific implementation. For example, a single array may be used for all registers or multiple arrays for different types of registers in various embodiments, e.g., since the actual number of arrays is an implementation choice. Additionally, the logic 300 may include a renaming logic 320. For example, the decoder 202 may be coupled to the renaming logic 320. As shown in FIG. 3, logic 320 may be coupled to the allocation control logic 302 and the RAT 212, for example, to map logical (or architectural) registers (such as those identified by operands of software instructions) to corresponding physical registers. This may allow for dynamic expansion of general use registers to use available physical registers. Also, the logic 300 may include a free pointers steering logic 322 which may be coupled to tables 310-314 and reclamation control logic 304 to forward pointers to the arrays 306 and/or 308 as will be further discussed below. In some embodiments, one or more of the components of FIG. 3 may be provided inside the decode unit 204 and/or schedule unit 206 of FIG. 2.

In accordance with some embodiments, the following is a list of the pointers used to manage recovery and reclamation of PRF entries that are no longer in use: (1) Retirement pointer (R)—which may mark the next entry to retire—It may also mark the last entry in the ROB 214 that may be reclaimed by the reclamation logic 304. This pointer may exist in the RHT/PHT and PRRT (e.g., items 310-314); (2) Allocation pointer (A)—which may mark the location to allocate the next uop—The area between the R and A pointers is allocated in the ROB 214. This pointer may exist in the RHT/PHT and PRRT (e.g., items 310-314); (3) Reclaimed pointer (F)—which may mark the last location that is available to be allocated. This pointer may exists in the RHT/PHT and PRRT (e.g., items 310-314); (4) Misprediction pointer (B)—this pointer defines the location of the mispredicted branch. This pointer may exist in the RHT/PHT (e.g., items 312 or 314); and (5) Mispredicted Bogus area end pointer (L) (not shown) pointers define the end of bogus area caused by a mispredicted branch (points to the last uop in the bogus area). This pointer may exist in the RHT/PHT (e.g., items 312 or 314).

As shown in FIG. 3, the Integer/FP/SIMD FL is handled as two circular FIFOs (First-In, First-Out) buffers (one for Integer (306) and another for FP/SIMD (308)) that hold a list of register identifiers that are not in-use. In an embodiment, these identifiers are inserted from one side of the FIFO using a tail pointer and consumed from the other end through a head pointer. The Integer FL array 306 allocates an entry in a PRF (e.g., Integer PRF) for any GP (General Purpose) integer register or an integer TEMP (Temporary) register that is received by the RAT 212. The FP/SIMD FL array 308 allocates an entry in a PRF (e.g., FP/SIMD PRF) whenever an X87, SSE FP, SSE SIMD, AVX or FP TEMP register is received by the RAT 212. These FIFOs may be shared in SMT between a plurality of threads. In some embodiments, the entries are allocated on demand and the balance is achieved by the limit imposed by the other arrays that are split into two halves in SMT in.

Moreover, at every cycle, the allocation control 302 may compute the number of entries (e.g., register identifiers) required from the FP FL and Integer FL to satisfy the register requirements of the chunk of instructions being allocated and the head pointers are updated accordingly. In one embodiment, the number of required entries is never greater than 4 per cycle. On the other hand, at reclamation (e.g., by reclamation control 304), the reclaimed entries are written into the correct FL array and the tail pointer will be advanced according to the number of reclaimed entries.

In some embodiments, the RHT 314 and PHT 312 tables are in charge of recovering the speculative state of the RAT 212 to the point where the mispredicted branch was allocated. They are also used to recover the RAT 212 state in case of an event or nuke. The RHT table 314 may provide the information needed for performing the recovery (e.g., the type of operation), while the PHT table 312 may provide the PDst value allocated for the value produced by that entry. This recovery mechanism may utilize a sequence of checkpoints. A checkpoint (CP) generally refers to a picture of the state of the RAT 212 at a given point in time. These checkpoints may be done periodically at allocation, e.g., for a select number of allocated instructions at a time. A checkpoint may be valid until the instruction where the next checkpoint was taken retires. CP is used to recover the RAT 212. The first CP is called architectural CP and it may be used instead of clearing the RAT 212 state into the RRF.

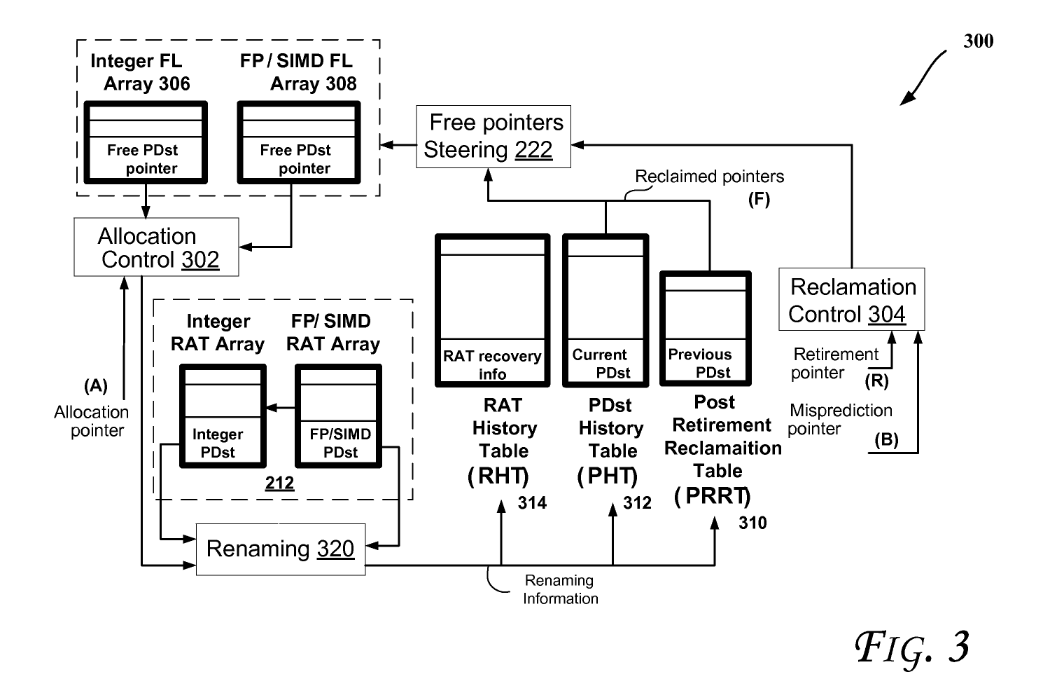

In some embodiments, the size of RHT 314 and PHT 312 is equal to the ROB 214 plus the number of uops between two consecutive checkpoints (referred to as checkpoint distance). The PHT 312 may be read during reclamation and recovery from two different pointers. FIG. 4A shows relative size for the ROB 214 and the PHT/RHT in ST (Single Thread) mode, according to an embodiment. Moreover, FIG. 4A may be used for both ST and SMT, for example, because for SMT the ROB, PHT/RHT and PRRT may be split into two halve. More particularly, an instruction allocates the PHT entry pointed by the A pointer at the allocation stage. Then, the A pointer moves to the next entry. On the other hand, the R pointer points to the oldest PHT entry in use. Therefore, the A pointer may never overtake the R pointer or the architectural CP. The R pointer points to the PHT entry where last retirement occurred. The latest instruction with checkpoint that has retired is called architectural CP and it is kept till another instruction with a checkpoint retires. At this point the PHT entries between the last and current Architectural CPs may be allocated.

In some embodiments, in the event of a branch misprediction or nuke the PHT 312 may be used to recover the RAT 212 and reclaim all registers allocated by flushed instructions. With the aim of reaching these two objectives, the B pointer may point to the PHT entry allocated by the offending instruction and the L pointer may point to the youngest PHT allocated entry. Moreover, the A pointer may move back to the position after the offending instruction. Hence, the recovery will walk the RHT/PHT tables from the nearest checkpoint older than the offending instruction, e.g., at a ratio of 4 entries per cycle, until the offending instruction is reached. The information regarding the RHT entries walked may be used to update the RAT 212. During this period of time the RAT 212 may be stalled. Once the recovery reaches the offending instruction, the RAT 212 has been recovered to the point where the offending instruction was allocated and new instructions are allowed to enter into the allocation stage. In parallel to the RAT recovery, reclamation may start from the uop following the offending instruction until the L-pointer is reached. During reclamation, the F pointer may walk the PHT 312 until it reaches the L pointer to reclaim the physical register identifiers allocated by the bogus instructions. The PDsts found in the walked entries between the B and L pointers may be sent back to the Integer/FP SIMD FL 306/308 depending on the PRF 211 to which they belong. The reclamation may encounter entries that were already reclaimed. In this case, the reclamation may not be repeated and the entries may be (for example, silently) ignored.

In SMT, the RHT 314 and PHT 312 may be split, e.g., into two halves such that each of two threads receives half of the Checkpoints and half of the entries. Since the size of these arrays may be tailored for ST performance and may be equal to ROB size+checkpoint distance, the size of each half may be ROB size/2+checkpoint disptance/2 as shown in FIG. 4B. In some embodiments, performance may be improved for SMT, for example, by having the size as rob_size+2*checkpoint distance; thus, making the size in SMT per thread ROB size/2+checkpoint distance.

In the above example, in case both threads have to recover the RAT 212 at the same time, one thread may recover its state first and then the second thread may recover its state. The allocation stage will resume allocating instructions when both RATs are recovered. Then, the allocation of the new instructions makes the A pointer of the PHTs to move up to 4 entries per cycle. The F pointer of both threads also moves (e.g., 4 entries per cycle) in order to reclaim the physical registers of the bogus identifiers. In an embodiment, only one F pointer may move every cycle, the same way as for the A pointer. Therefore, the A pointer and the F pointer of the same thread may meet if for instance we always allocate entries from one thread and move the F pointer of the other thread. In this case, the A pointer would be stalled along with the allocation of instructions of the thread. Otherwise, the A pointer would overwrite entries that the F pointer has not walked yet for reclamation. Another alternative in order to avoid this race condition among the A and F pointers is to synchronize them. In this alternative, the thread that allocates instructions in a given cycle and therefore will move its A pointer in the PHT 312 will be the same than the one that moves the F pointer. In this case, it may be guaranteed that the A pointer would not meet the F pointer before the F pointer reaches the L pointer and then reclamation is completed. Another policy may be to decide which thread to reclaim based on the thread that has the lower amount of resources.

Referring to FIG. 3, the PRRT 310 may be a contiguous array that contains the PRF 211 entries that will be reclaimed on retirement. The PRRT 310 may contain a mixture of FP/SIMD and integer PRF entries to be reclaimed in an embodiment. Alternatively, separate PRRTs may be used for different types of entries, including FP/SIMD or integer. Entries may be written into the PRRT on allocation when the RAT 212 identifies that an allocated uop releases corresponding PRF entries. The rate is not a constant and may vary between “no identified entries” to 10 candidates for release per clock, for example. In an embodiment, entries are reclaimed on retirement in a constant rate of four PRF 211 entries per clock.

Moreover, in some embodiments, one PRF 211 entry may be released per allocated uop and written into the PRRT 310. If a uop does not allocate a PRF entry, then it may not release a PRF entry. A uop that allocates a PRF entry may release several PRF entries or none, e.g., in case it is aliased onto other pointers. Aliasing may occur due to flags aliasing, partial register aliasing, due to move elimination aliasing (for example, by not allocating a PRF entry when a move operation occurs, copying the PRF entry pointer and monitoring multiple reference to the PRF entry following a move operation and reclaiming the PRF entry into the PRRT when the last reference is allocated) making a single PRF entry to be used to store two or more architectural values, etc. For example, one PRF entry may hold the value of architectural register (such as EAX) and Arithmetic flags (such as CF). In another example, a single PRF entry may hold the value of two architectural registers (e.g., EAX and ABX) due to move elimination. In this case, the PRF location may be referred to as aliased PRF entry since it aliases two different renamed architectural registers. Releasing an aliased PRF 211 entry may require all the aliased architectural registers it represents be overwritten. In these cases, a uop may release more than one PRF entry as a result of the resolution of one or more of the aliasing cases it represented. The RAT 212 may monitor the aliasing case and it may release an entry into the PRRT 310 when it is free of all aliasing.

Referring to FIG. 4C, in an embodiment, as discussed previously, the PRRT 310 may be accessed using three pointers—the Allocation pointer (A), the Retirement pointer (R), and the Free pointer (F). On allocation, the Allocation pointer (A) may be used to place the next PDst to be reclaimed on retirement. The F pointer (e.g., Reclamation pointer) may point to the next entry to be reclaimed and the R pointer may point to the retirement location. When PRRT 310 reclamation is chosen (e.g., no PHT 312 reclamation is active), the F pointer may reclaim four entries per clock cycle until it reaches the R pointer. The PRRT 310 may use the Guarantee indication from the ROB (e.g., indicating a uop retired safely) to trigger the post retirement reclamation.

In some embodiments, only the A pointer of the PRRT 310 is recovered following a branch misprediction or a nuke. This may be achieved via checkpointing the pointer value on each checkpoint and then incrementing it during the recovery process until the proper value is calculated. The F pointer may not pass the R pointer and therefore there may be no need to recover its value on a nuke. Referring to FIG. 4D, on SMT, the PRRT 310 may be split, e.g., into two halves. Each of the two threads in this example may have its own half that is controlled in the same way as the PRRT 310 is handled in ST using the three pointers—A, F and R. The pointers may be used in the same manner and the A pointer recover in the same manner also.

Furthermore, the reclamation of PRF 211 entries from the PHT 312 and PRRT 310 into the FL arrays may be autonomous and not depend on the RAT 212 recovery process. This means that PHT 312 reclamation may terminate before RAT 212 recovery completes, in which case PRRT reclamation may resume before new uops enter the RAT 212. PHT 312 reclamation may terminate after RAT 212 recovery completes, in which case PRRT 310 reclamation may still be stalled while new uops enter the RAT 212. Moreover, the PRRT 310 reclamation may work independent of the thread selection, whereas PHT 312 reclamation may ping-pong according to the allocation thread-selection. The ping pong algorithm used in SMT may be implemented considering the occupancy of the PRRT 310s. This may ensure that both PRRT 310s are drained in a balanced way, with simple pointer arithmetic. It may also reduce situations where a thread is stalled because it runs out of PRRT 310 entries and most of these PRRT 310 entries could be reclaimed.

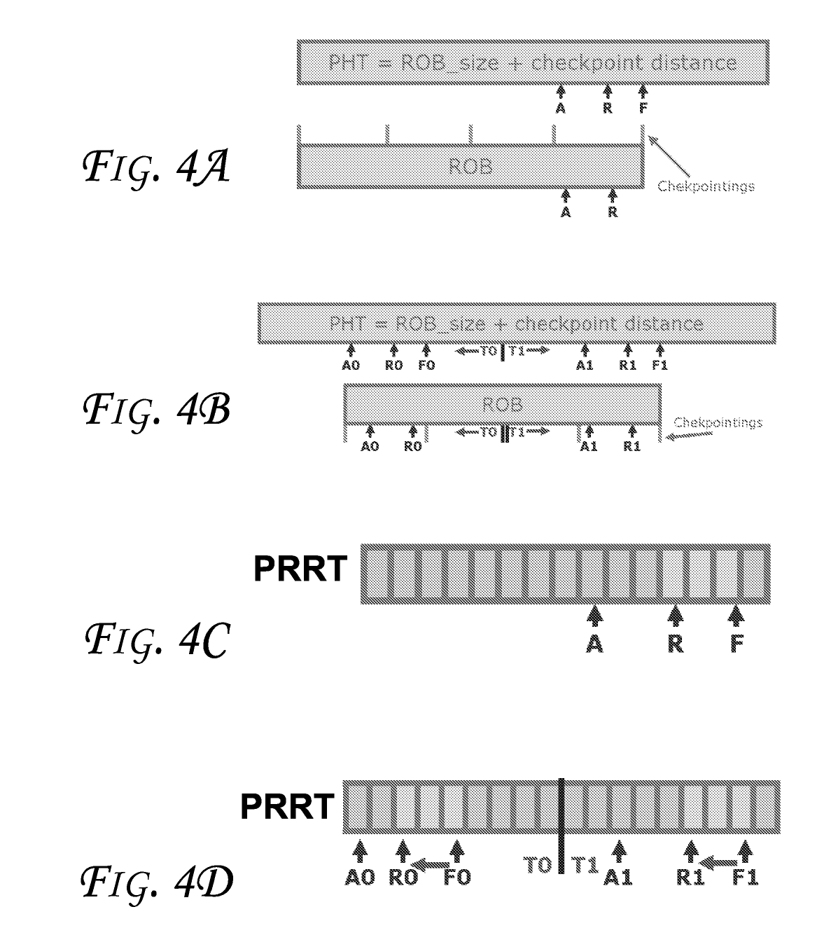

FIG. 5 illustrates a flow diagram of a method 500 to update free list information, according to an embodiment of the invention. In some embodiments, various components discussed with reference to FIGS. 1-4 and 5-7 may be utilized to perform one or more of the operations discussed with reference to FIG. 5.

Referring to FIGS. 1-5, at an operation 502, data (e.g., architectural and/or speculative) may be stored in one or more PRFs, such as discussed herein, for example, with reference to FIG. 3. At an operation 504, it may be determined whether change corresponding free physical identifiers has occurred. If so, an operation 506 may update corresponding free list information, e.g., such as discussed herein, for example, with reference to FIG. 3.

Some of the embodiments discussed herein may allow for: (a) implementation of a PRF structure with enhancement to the forward only recovery CP scheme (e.g., where an architectural CP is used and forward recovery is done for a branch misprediction, an event and/or a nuke); (b) the positive reclamation (e.g., referring to where reclamation is performed following normal retirement and is triggered in normal uninterrupted operation) and negative reclamation (e.g., referring to where reclamation is performed following a branch misprediction, an event or nuke and is triggered by a clear or nuke) to be autonomous operations that run in parallel and in the background of allocation and retirement respectively (allocation or retirement may be seldom stalled due to reclamation, for example); (c) the positive reclamation scheme with full bandwidth reclamation (e.g., referring to autonomous reclamation that is not linked to recovery of the RAT) of a register alias architecture (e.g., that may release up to 10 aliased registers per clock cycle in some embodiments, for example depending on aliasing scheme used to rename the registers); (d) positive reclamation to be done as fast as possible without introducing any bubbles; (e) accurate amount of PRF entries to be allocated per clock and no need to recycle entries that are not used; and/or (f) operates with no affect on reclamation of resources following a branch misprediction, event or nuke.

FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. For example, one or more of the processors 602 may include one or more of the cores 106, e.g., including logic 300. Also, the operations discussed with reference to FIGS. 1-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 114 of FIG. 1). The memory 612 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and other components shown in FIG. 6 (including but not limited to the MCH 608, one or more components of the MCH 608, etc.) may be combined to form a single chip. Furthermore, a graphics accelerator may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6.

In an embodiment, the processors 702 and 704 may be one of the processors 602 discussed with reference to FIG. 6, e.g., including logic 300. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a graphics circuit 734 via a graphics interface 736, e.g., using a PtP interface circuit 737.

At least one embodiment of the invention may be provided within the processors 702 and 704. For example, one or more of the cores 106 of FIGS. 1-4 may be located within the processors 702 and 704. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7.

The chipset 720 may communicate with a bus 740 using a PtP interface circuit 741. The bus 740 may communicate with one or more devices, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device 747, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed herein.

Additionally, such computer-readable media may be downloaded as a computer program product, wherein the program may be transferred from a remote computer (e.g., a server) to a requesting computer (e.g., a client) by way of data signals in a carrier wave or other propagation medium via a communication link (e.g., a bus, a modem, or a network connection).

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a physical register file to store speculative data and architectural data corresponding to a plurality of registers; and
a free list logic to maintain free physical register identifiers corresponding to the plurality of registers;
wherein an instruction is to read the architectural data from the physical register file at dispatch.

2. The processor of claim 1, wherein the free list logic is to reclaim the plurality of registers in an order that differs from an order the plurality of registers were allocated.

3. The processor of claim 1, wherein the free list logic is to comprise:
one or more free list arrays to store free physical pointers corresponding to the free physical register identifiers;
an allocation control logic to allocate the stored free physical pointers; and
a reclamation control logic to reclaim the free physical register identifiers based on a plurality of pointers.

4. The processor of claim 3, wherein the plurality of pointers are selected from a list consisting of a retirement pointer, an allocation pointer, and a misprediction pointer.

5. The processor of claim 1, wherein the processor is to perform one or more of: (a) to use an architectural checkpoint corresponding to a forward recovery for a branch misprediction, an event or a nuke; (b) to perform a positive reclamation and a negative reclamation autonomously and in parallel; (c) to perform the positive reclamation with full bandwidth reclamation independent of recovery of a register alias table (RAT); or (d) to operate with no affect on reclamation of resources following a branch misprediction, event or nuke.

6. The processor of claim 1, wherein the free list logic is to comprise:
a register alias table (RAT) history table (RHT) to store information corresponding to a RAT;
a physical destination history table (PHT) to store one or more current physical destinations; and
a post retirement reclamation table (PRRT) to store one or more previous physical destinations.

7. The processor of claim 6, further comprising logic to recover the RAT based on information stored in the RHT and PHT.

8. The processor of claim 6, wherein the processor is to execute at least a first thread and a second thread, wherein the free list logic is to reclaim one or more entries in an order comprising: (1) first, reclaim one or more entries from the PHT corresponding to the first thread; (2) second, reclaim one or more entries from the PHT corresponding to the second thread; and (3) third, reclaim one or more entries from the PRRT according to an amount of PRRT entries corresponding to each of the first or second thread.

9. The processor of claim 1, further comprising a memory to store the free physical register identifiers.

10. The processor of claim 9, further comprising a fetch unit to fetch a new instruction, wherein the new instruction is to allocate at least one of the free physical register identifiers from the memory.

11. The processor of claim 1, wherein a value corresponding to a register, stored in the physical register file, is valid from allocation until the next retirement of the register.

12. The processor of claim 1, further comprising a plurality of physical register files.

13. The processor of claim 1, further comprising one or more processor cores, wherein at least one of the one or more processor cores is to comprise the physical register file and the free list logic.

14. A method comprising:
storing speculative data and architectural data corresponding to a plurality of registers in a physical register file;
updating a memory to maintain free physical register identifiers corresponding to the plurality of registers; and
reading the architectural data from the physical register file at dispatch of an instruction.

15. The method of claim 14, wherein updating the memory comprises updating ne or more free list arrays, a register alias table (RAT) history table (RHT), a physical destination history table (PHT), and a physical destination history table (PHT).

16. The method of claim 14, further comprising reclaiming the plurality of registers is performed in an order that differs from an order the plurality of registers were allocated.

17. A computing system comprising:
a memory to store an instruction; and
a processor core to execute the instruction, the processor core to comprise:
a physical register file to store speculative data and architectural data corresponding to a plurality of registers; and
a free list logic to maintain free physical register identifiers corresponding to the plurality of registers;
wherein an instruction is to read the architectural data from the physical register file at dispatch.

18. The system of claim 17, wherein the free list logic is to reclaim the plurality of registers in an order that differs from an order the plurality of registers were allocated.

19. The system of claim 17, wherein the free list logic is to comprise:
a register alias table (RAT) history table (RHT) to store information corresponding to a RAT;
a physical destination history table (PHT) to store one or more current physical destinations; and
a post retirement reclamation table (PRRT) to store one or more previous physical destinations.

20. The system of claim 17, further comprising an audio device coupled to the processor core.
